(19) United States
(12) Patent Application Publication
(10) Pub. No.: US 2006/0124559 A1
(43) Pub. Date: Jun. 15, 2006

(54) Process for generating useful biomass from organic waste streams

(75) Inventors: Chris E. Choate, Dixon, CA (US); Greg Pryer, Dixon, CA (US); Bennie Anselmo, Dixon, CA (US)

Correspondence Address: CARR & FERRELL LLP, 2200 GENG ROAD, PALO ALTO, CA, 94303, US

(73) Assignee: Norcal Waste Systems, Inc.

(21) Appl. No.: 11/343,515

(22) Filed: Jan. 30, 2006

Related U.S. Application Data
(62) Division of application No. 10/954,550, filed on Sep. 29, 2004.

(51) Int. Cl. C02F 11/12

(52) U.S. Cl. 210/768

(57) ABSTRACT

Methods for generating a biomass product having a high volatile solid content, biomass products made by the methods, and apparatus for performing the method are provided. An exemplary method fractions an organic waste stream into a residual component and a biomass component, and the biomass component is further processed to reduce the sizes of the particles therein to produce the biomass product. The volatile solid content of the biomass product, in some embodiments, is at least 80% of a total solid content. An exemplary apparatus for generating the biomass product includes a separation drum, such as a Trommel screen, having a screen for passing the biomass component, and a grinder for further processing the biomass component to produce the biomass product.

### CROSS-REFERENCE TO RELATED APPLICATIONS

This application is a divisional of U.S. application Ser. No. 10/954,550 filed on Sep. 29, 2004 and claims priority therefrom pursuant to 35 U.S.C. §120.

### BACKGROUND OF THE INVENTION

1. Field of the Invention

The disclosure relates generally to the field of waste management, and more particularly to apparatus and methods for separating useful biomass from mixed organic wastes.

2. Description of the Prior Art

For both environmental and economic reasons, municipalities are increasingly interested in reducing the amount of material directed to their landfills. Accordingly, recycling and composting programs have become widely accepted for both commercial and residential waste. Generally, recycling programs require that the waste be separated by type, either at a point of collection (source separated) or further along, such as at a transfer station. Recyclable components can include glass, metals, and plastics, while compostable components can include plant matter, food stuffs, wood, cardboard, and paper. Once separated, waste materials are commonly referred to as “source separated,” and source separated materials that are collected together from many collection points constitute a “single stream.”

In the case of composting, waste collection companies are typically required to pay for the composting or disposal service. So, although directing waste into composting programs reduces the burden on landfills, it adds to the expense of waste collection for customers of the waste collection companies. Accordingly, what is needed is a more economical and sustainable alternative to composting.

### SUMMARY

The present invention provides methods for generating a biomass product having a high volatile solid content, the biomass product made by the methods, and apparatus for performing the method. Exemplary methods comprise fractioning an organic waste stream into a residual component and a biomass component. The biomass component is further processed to reduce a particle size thereof in order to produce the biomass product. The volatile solid content of the biomass product, in some embodiments, is at least 80% of the total solid content of the biomass product. An apparatus for generating a biomass product from an organic waste stream, according to an embodiment of the invention, comprises a rotatable separation drum, such as a Trommel screen, having a screen for passing a biomass component having particles that are sized smaller than a mesh size, and a grinder for reducing the particle size of the biomass component to produce the biomass product.

In some embodiments of the method, fractioning the organic waste stream includes screening the organic waste stream such that the biomass component passes through a screen while the residual component does not. Screening the organic waste stream can include tumbling the organic waste stream in a separation drum including the screen. Apparatus of the present invention that include the separation drum, in some embodiments, have replaceable screens. This allows the mesh size of the screens to be varied according to the quality of the organic waste stream and/or the desired quality of the biomass product. In some embodiments, the mesh size of the separation drum varies between the ends of the separation drum. Some apparatus of the present invention include more than one separation drum, arranged in series, for example, where a screen of each separation drum has a different mesh size.

In some embodiments of the method, processing the biomass component to reduce the particle size includes grinding, for example, with a hammer mill. Thus, processing the biomass component, in some embodiments, includes reducing the particle size to ¾ inch or less, ¼ inch or less, or 1/16 inch or less. Exemplary methods of the present invention can also comprise homogenizing the organic waste stream before fractioning the organic waste stream. Some embodiments of the apparatus of the present invention employ a mixer, such as a dairy feed mixer, to process the organic waste stream before it is received by the separation drum.

### BRIEF DESCRIPTION OF DRAWINGS

FIG. 1 is a top view of an exemplary embodiment of an apparatus for producing a biomass product from an organic waste stream according to an embodiment of the invention.

FIG. 2 is a side view of a portion of the apparatus of FIG. 1.

FIG. 3 shows an enlarged portion of a separation drum of the apparatus of FIG. 1.

FIG. 4 shows a cross-sectional view of the separation drum of the apparatus of FIG. 1.

### DETAILED DESCRIPTION

The present invention provides a more economical alternative to handling source separated and similar organic waste streams. Rather than directing all such material to composting or landfills at considerable cost to waste collection companies, the present invention fractions the waste stream into two primary components, a valuable biomass product that is suitable for various applications and a residual component for composting or disposal.

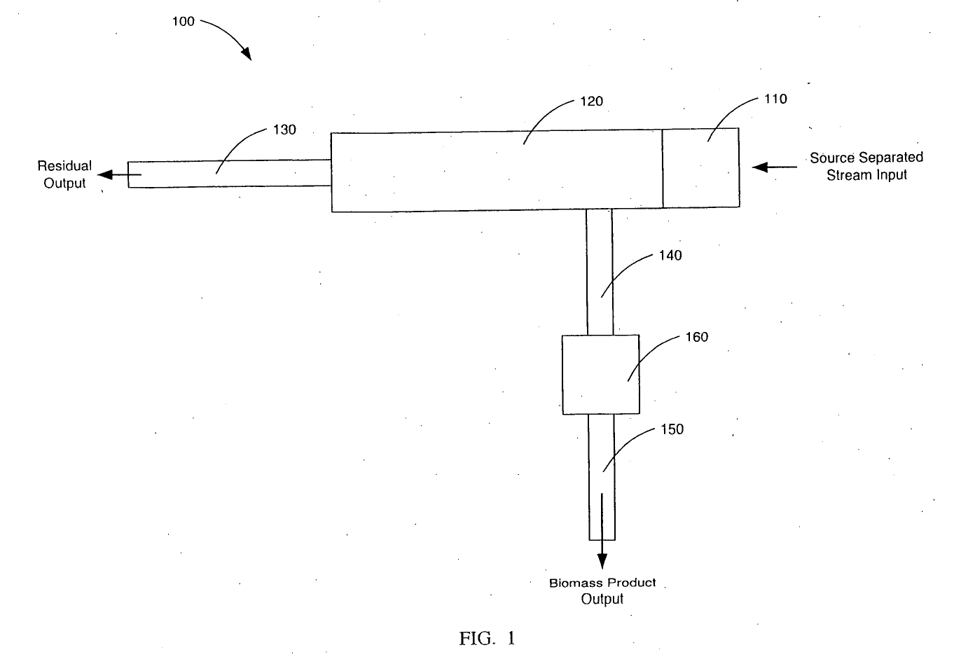

FIG. 1 is a top view of an exemplary embodiment of an apparatus 100 for producing a biomass product from an organic waste stream. The organic waste stream can comprise, for example, a source separated organic waste stream collected from residences, businesses, and institutions. The source separated organic waste stream can include yard wastes such as branches, grass clippings, and other plant matter; food waste including processed foods, vegetable matter, meat and dairy products, kitchen grease and bones; paper and cardboard contaminated with food, fat, or kitchen grease; organic paper associated with food preparation or consumption such as paper towels, paper plates, tissue, waxed paper, and waxed cardboard; sawdust and wood scraps; and other compostable waste materials. The organic waste stream may also include some non-organic contamination. The apparatus 100 comprises an optional mixer 110, a separation drum 120, conveyer belts 130, 140, and 150, and a grinder 160. FIG. 2 shows a side view of the separation drum 120 and a further conveyer belt 200 disposed beneath the separation drum 120.

In operation, the organic waste stream is introduced into the apparatus 100 at a first end 210 of the separation drum 120. The separation drum 120 is disposed at an angle to the ground so that gravity causes the organic waste stream to travel from the first end 210 to a second end 220 as the separation drum 120 rotates. An enlarged portion, 3, of the separation drum 120 is shown in FIG. 3 and illustrates that a barrel of the separation drum 120 comprises a screen 300, or multiple interchangeable screens 300 as described in more detail below.

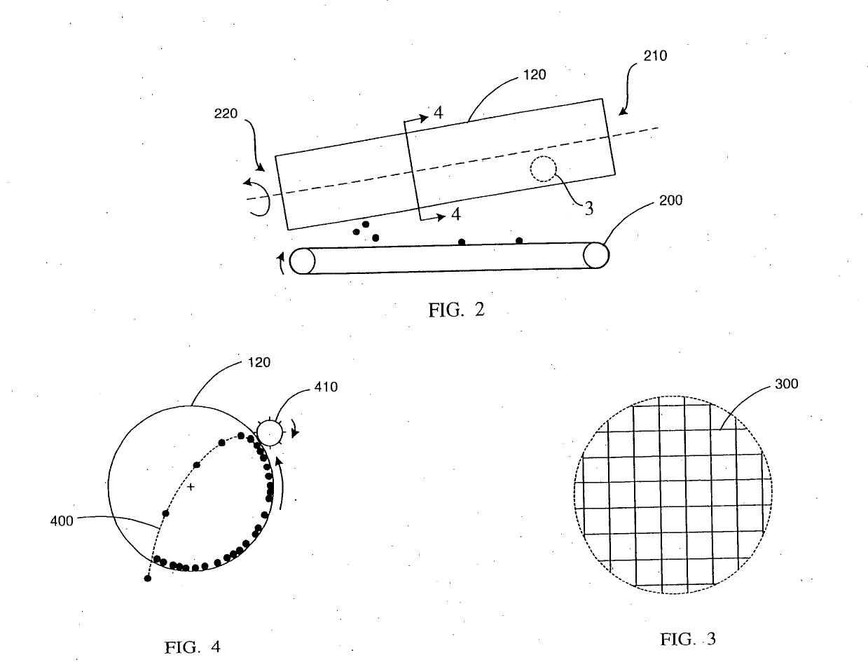

FIG. 4 is a cross-sectional view of the separation drum 120 taken along the line 4-4 in FIG. 2. It can be seen in FIG. 4 that the organic waste stream is carried by centrifugal force along the interior surface of the barrel of the separation drum 120 as the separation drum 120 rotates until gravity overcomes the centrifugal force and causes the organic waste stream to drop along a trajectory 400. The organic waste stream then strikes the screen 300 near a bottom of the barrel. Where the organic waste stream strikes the screen 300, some of the organic waste stream passes through the screen 300 and falls onto the conveyor belt 200 (FIG. 2). This portion of the organic waste stream, a biomass component, is carried by the conveyor belt 200 to the conveyor belt 140 (FIG. 1) and then to the grinder 160 (FIG. 1) where the biomass component is further processed into the biomass product.

The portion of the organic waste stream that does not pass through the screen 300 is again carried up the interior surface of the separation drum 120. In this way, the organic waste stream is repeatedly tumbled within the separation drum 120 as it travels from the first end 210 to the second end 220. The smallest, and most desirable, components of the organic waste stream eventually pass through the screen 300, and what does not pass through the screen 300 falls out of the second end 220 of the separation drum 120 and onto conveyor belt 130 as the residual component. This residual component, which can consist primarily of cardboard, paper, wood, and non-organic materials, for example, can be hauled away for composting or other disposal.

Various aspects of the apparatus 100 described above can be varied or modified, as discussed below. For example, in some embodiments, the apparatus 100 includes the mixer 110 at the first end 210 of the separation drum 120. In these embodiments, the organic waste stream is received by the mixer 110, processed therein, and transferred into the separation drum 120. The mixer 110 processes the organic waste stream in order to make it more homogenous, in part, by breaking up larger pieces therein. For instance, closed sacks or bags in the organic waste stream may not otherwise bust open in the separation drum 120 and will pass into the residual component even though they contain material that should be directed to the grinder 160. An exemplary mixer 110 is a dairy feed mixer for mixing feed stock for livestock. The dairy mixer is analogous to a scaled-up egg beater operating at approximately 18 RPM. It will be appreciated that the mixer 110 can operate either continuously or in batches.

Aspects of the separation drum 120 can also be varied or modified. The diameter and length of the separation drum 120 can be scaled as necessary. In some embodiments, the rate of rotation of the separation drum 120 is adjustable to optimize the trajectory 400 (FIG. 4) so that the organic waste stream strikes the screen 300 with as much force as possible. The angle that the separation drum 120 makes to the ground can also be adjusted to vary the rate at which the organic waste stream passes through from the first end 210 to the second end 220.

In some embodiments, the separation drum 120 also includes a rotating brush 410 (FIG. 4) that contacts an exterior side of the barrel along the length thereof. The brush 410 is disposed near the top of the trajectory 400 so that bristles of the brush 410 poke through the screen 300 and help dislodge the organic waste stream from the interior surface of the barrel so that it falls properly. An exemplary separation drum 120 is a Trommel screen such as the Trommel 830 having a 30 foot length and an 8 foot diameter.

Additionally, the size of the mesh of the screen 300 (FIG. 3) can be adjusted. It has been found that the smaller the mesh size, the higher the quality of the biomass product, but the lower the yield of biomass product from the organic waste stream. In some embodiments, the screens 300 are interchangeable so that different mesh sizes can be employed, depending on the quality of the organic waste stream and/or the desired quality of the biomass output. In some embodiments, the size of the mesh can vary from the first end 210 to the second end 220, for example, progressing from a larger mesh to a smaller mesh. Exemplary meshes include 6 inch, 4 inch, and 1¼ inch. Although a square mesh is shown in FIG. 3, other meshes, such as hexagonal and triangular, can also be used. While exemplary embodiments of the apparatus 100 include the separation drum 120, it will be understood that other screening methods can also be employed. A disc screen or vibrating screen table can replace the separation drum 120, for instance.

The biomass component that passes through the screen 300 is caught by the conveyor belt 200 beneath the separation drum 120, transferred to the conveyor belt 140, and carried to the grinder 160 for further size reduction. The biomass component is typically organic materials such as food waste and yard waste, though a small amount of inert and/or non-organic material is to be expected. Where the organic waste stream initially includes whole melons, oranges, eggplants, and so forth, the mixer 110 can help break up these objects so that they more readily pass through the screen 300.

It will be appreciated that a maximum particle size of the biomass component that passes the screen 300 will be limited by the mesh size of the screen 300. It should be noted that as used herein, the term “particle” can describe organic matter on a size scale that is larger than is typically thought of for particles in other art fields. For the purposes of this disclosure, any piece, chunk, segment, or bit of organic matter can be treated as a particle. Thus, particles of organic matter can encompass anything from leaf fragments and coffee grounds to corn cobs and watermelon rinds.

The grinder 160 further reduces the sizes of the particles in the biomass component to meet particular end-use requirements of the biomass product. Exemplary final size requirements specify a maximum size and allow for any distribution below the maximum, for example, ¾ inch or less, ¼ inch or less, and 1/16 inch or less. An exemplary grinder 160 is a vertical-feed hammer mill. Like the optional mixer 110, embodiments of the grinder 160 can operate either continuously or on batches.

It will be appreciated that, in some embodiments, more than one apparatus 100 can be placed in series such that the separation drum 120 of one feeds into the separation drum 120 of the next. Each apparatus 100 can have a separation drum 120 with a different mesh size for the screen 300 so that each apparatus 100 produces a different quality biomass product. Additionally, some embodiments are configured such that the residual component is returned to the first end of the separation drum 120 for additional processing.

The biomass product that is generated by the apparatus 100 has a high percentage of volatile solid to total solid content that in some embodiments is at least 80%. The volatile solid content is expressed as a percentage of a total solid content which can be determined, for example, by a procedure such as ASTM E1756-01. Another procedure, ASTM E1755-01, can be used to determine the non-volatile solid content. The volatile solid content can be determined as the difference between the total solid content and the non-volatile solid content. The volatile solid content can be a measure of the quality of the biomass product with quality scaling with the volatile solid content.

The high volatile solid content makes the biomass product a valuable feedstock for many different types of facilities and processes. For example, the biomass product can be converted to organic and non-organic solid and liquid fertilizers as well as high quality organic and non-organic composts. The biomass product can also be used in one and two phase anaerobic digestion facilities, such as Publicly Owned Treatment Works (POTW), for the production of either heat from boilers or electricity from fuel cells. Furthermore, the biomass product can be processed to provide alternative fuels including biodiesel, natural gas, and hydrogen, as well as plastics, polymers, and other chemicals. Some of these processes can employ technologies such as catalytic cracking, distillation, gasification, hydrolysis, and pyrolysis. It will be appreciated that many of these end-uses beneficially reduce dependence on petroleum.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for generating a biomass product comprising:
fractioning an organic waste stream into a residual component and a biomass component having a high volatile solid content; and
reducing a particle size of the biomass component to produce the biomass product.

2. The method of claim 1 wherein fractioning includes screening the organic waste stream such that the biomass component passes through a screen while the residual component does not.

3. The method of claim 2 wherein screening the organic waste stream includes tumbling the organic waste stream in a separation drum including the screen.

4. The method of claim 1 wherein reducing the particle size of the biomass component includes grinding.

5. The method of claim 1 wherein reducing the particle size of the biomass component includes reducing the particle size to ¾ inch or less.

6. The method of claim 1 wherein reducing the particle size of the biomass component includes reducing the particle size to ¼ inch or less.

7. The method of claim 1 wherein reducing the particle size of the biomass component includes reducing the particle size to 1/16 inch or less.

8. The method of claim 1 further comprising homogenizing the organic waste stream before fractioning the organic waste stream.

9. The method of claim 1 wherein the organic waste stream is a source separated waste stream.

10. The method of claim 1 further comprising returning the residual component to the organic waste stream.

11. A biomass product made by the method of claim 1.

12. The biomass product of claim 11 wherein the volatile solid content is at least 80% of the total solid content of the biomass product.

13. A method for generating a biomass product comprising:
receiving a source separated waste stream;
fractioning the source separated waste stream into a residual component and a biomass component having a high volatile solid content; and
transforming the biomass component to the biomass product by grinding the biomass component.

14. The method of claim 13 wherein the residual component consists primarily of cardboard, paper, wood, and non-organic materials.

15. The method of claim 13 further comprising homogenizing the source separated waste stream before fractioning the source separated waste stream.

16. The method of claim 13 wherein the biomass product has a particle size of ¾ inch or less. ¼ inch or less, and 1/16 inch or less

17. The method of claim 13 wherein the biomass product has a particle size of 1/16 inch or less.

18. The method of claim 13 wherein transforming the biomass component to the biomass product is achieved solely by grinding the biomass component.
